(19) United States
(12) Patent Application Publication
(10) Pub. No.: US 2025/0109973 A1
(43) Pub. Date: Apr. 3, 2025

(54) MAGNETIC POSITION SENSOR AND CALIBRATION THEREOF

(71) Applicant: TEXAS INSTRUMENTS INCORPORATED, DALLAS, TX (US)

(72) Inventors: Preetinder GARCHA, WATERTOWN, MA (US); Lawrence COTTON, ALLEN, TX (US); Dok Won LEE, MOUNTAIN VIEW, CA (US); Baher HAROUN, ALLEN, TX (US)

(21) Appl. No.: 18/478,361

(22) Filed: Sep. 29, 2023

(51) Int. Cl. G01D 18/00; G01D 5/14

(52) U.S. Cl. CPC G01D 18/001; G01D 5/145

(57) ABSTRACT

In a described example, a position sensor can include a first magnetic field sensor unit having a first sensor output, a second magnet field sensor unit having a second sensor output, one or more coils having one or more footprints overlapping the first and second magnetic field sensor units, and a processing circuit having a first sensor input, a second sensor input, a current terminal, and a sensing output, the first sensor input coupled to the first sensor output, the second sensor input coupled to the second sensor output, and the current terminal coupled to the one or more coils.

### TECHNICAL FIELD

This description relates to magnetic position sensors and, more specifically, to systems and methods for calibrating the magnetic position sensors.

### BACKGROUND

There are several different ways to sense position. For example, one option available for position measurement includes using hall-effect sensors. Hall-effect sensors are configured to measure magnetic fields and produce an output voltage representative of the sensed field. The output voltages can be converted to position measurements for further processing and control.

### SUMMARY

In a described example, a magnetic position sensor can include a first magnetic field sensor unit having a first sensor output, a second magnet field sensor unit having a second sensor output, one or more coils having one or more footprints overlapping the first and second magnetic field sensor units, and a processing circuit having a first sensor input, a second sensor input, a current terminal, and a sensing output, the first sensor input coupled to the first sensor output, the second sensor input coupled to the second sensor output, and the current terminal coupled to the one or more coils.

In a described example, a sensor device can include a semiconductor die, a first magnetic field sensor unit having a first sensor output on a first side of the semiconductor die, a second magnet field sensor unit having a second sensor output on a second side of the semiconductor die opposing the first side, one or more coils having one or more footprints overlapping the first and second magnetic field sensor units, and a processing circuit having first and second sensor inputs, a current terminal, and a processing output, the first sensor input coupled to the first sensor output, the second sensor input coupled to the second sensor output, and the current terminal coupled to the one or more coils.

In a described example, a method can include providing a calibration current to one or more coils having one or more footprints that overlap a first magnetic field sensor unit and a second magnetic field sensor unit of a sensor device, receiving a first sensor signal from the first magnetic field sensor unit, the first sensor signal representing one or more calibration magnetic fields provided by the one or more coils responsive to the calibration current and a second magnetic field, receiving a second sensor signal from the second magnetic field sensor unit, the second sensor signal representing the one or more calibration magnetic fields and a third magnetic field, extracting a first measurement of the one or more calibration magnetic fields and a second measurement of the second magnetic field from the first sensor signal, extracting a third measurement of the one or more calibration magnetic fields and a fourth measurement of the third magnetic field from the second sensor signal, and providing a signal representing a position at a position output based on the first, second, third, and fourth measurements.

### BRIEF DESCRIPTION OF THE DRAWINGS

FIG. 1A is a schematic diagram of an example on-axis position sensing system.

FIG. 1B is a schematic diagram of an example off-axis position sensing system.

FIG. 1C is a schematic diagram of an example linear position sensing system.

FIG. 2 is a schematic diagram illustrating a top plan view of an example semiconductor device that includes a magnetic position sensor.

FIG. 3 is a schematic diagram illustrating a top plan view of an example magnetic field sensor unit of a magnetic position sensor.

FIGS. 4A, 4B, 4C, and 4D are schematic diagrams illustrating top plan views of examples of semiconductor devices that include a magnetic position sensor.

FIGS. 4E and 4F are schematic diagrams illustrating cross-sectional views of example magnetic position sensors.

FIG. 5 is a schematic diagram illustrating an example circuit with single source auto-calibration for magnetic position detection.

FIG. 6 is a schematic diagram illustrating example internal components of a magnetic position detection system.

FIGS. 7, 8, and 9 are schematic diagrams illustrating example calibration techniques for a magnetic position sensor.

FIG. 10 is a schematic diagram illustrating a top plan view of an example integrated circuit (IC) of a magnetic position sensing system.

FIG. 11 is a schematic diagram illustrating a top plan view of another example semiconductor device that includes a magnetic position sensor.

FIG. 12 is a flow diagram showing an example method for magnetic position sensing and calibration.

### DETAILED DESCRIPTION

This description relates to magnetic position sensors and to systems and methods for calibrating the magnetic position sensors, such as to provide for stray field immune position sensing. Generally, a high accuracy is desired for rotary/linear position sensing. For example, certain automotive applications can have tight tolerances which are required to be met under the International Standards Organization (ISO). Examples of such requirements include <0.5 degree angular error drift, stray field immunity up to 5 mT DC fields in any direction, etc. While a magnetic position sensor can include multiple magnetic field sensors (e.g., hall-effect sensors/elements) to provide differential signals for position sensing and stray magnetic field cancellation, gain mismatches among the magnetic field sensors can lead to incomplete cancellation of stray magnetic field in the sensor outputs, which can degrade the position sensing accuracy. For example, sensitivity mismatch and sensitivity drift associated with changes in temperature, stress, or humidity can lead to higher angular error drift. Additionally, the distance between magnetic field sensors of a magnetic position sensor that provide the differential outputs may be maximized (e.g., by placing the magnetic field sensors on opposite edges/corners of a die) to generate higher differential signals, but due to the increased separation distance, the magnetic field sensors can be more prone to sensitivity mismatch. All these can increase the gain mismatches and degrade the position sensing accuracy.

As described herein, a magnetic position sensor device includes circuitries to support an auto-calibration operation to mitigate the aforementioned gain errors, including sensitivity mismatch and sensitivity drift, for example. According to one example, a magnetic position sensor includes multiple magnetic field sensor units and one or more coils, in which the one or more coils have one or more footprints that overlap the respective magnetic field sensor units. In an example where there is more than one coil, the coils are connected in series and a calibration current can be injected into all of the coils to generate one or more calibration magnetic fields for each magnetic field sensor unit. Each sensor unit includes one or more Hall-effect elements configured to produce a sensor voltage in response to sensing a magnetic field. The magnetic field being sensed can include a combination of, for example, an external magnetic field to be sensed by the multiple magnetic field sensor units, a calibration magnetic field generated by the coils, and/or a stray magnetic field, and the sensor voltage generated by each sensor unit can represent a combination of these magnetic fields. As described herein, the magnetic position sensor (or associated circuitry) can extract the calibration component from the sensor voltage and compute a gain factor (or a gain corrector factor) based on the calibration component and a calibration magnetic field strength determined based on, for example, the calibration current which is known. The magnetic position sensor can be further configured to implement gain correction for the signal path (or signal chain) of each sensor unit using the gain factor/gain correction factor, thereby mitigating the gain error between the sensor units caused by the sensitivity mismatch and sensitivity drift. With the gain error mitigated or even eliminated, stray field immunity can be achieved. Also, because the same calibration current is injected into all of the coils, errors associated with inaccurate calibration current can be cancelled out based on a ratiometric angle or position calculation determined from the respective sensor voltages.

Further, the one or more coils can be utilized as test coils coupled to an external current source. The external current source can supply a test current for trimming at wafer test and/or bench test, which can enable a reduction of test costs.

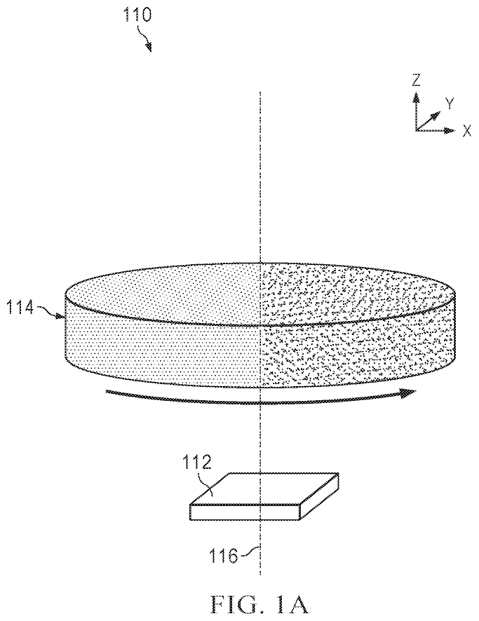

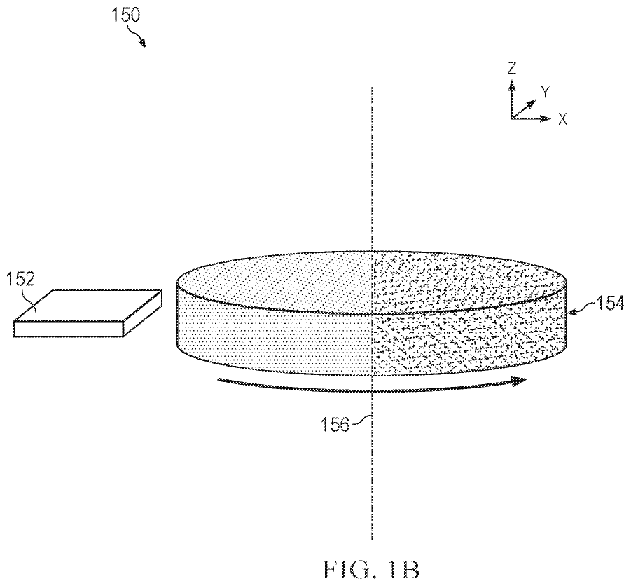

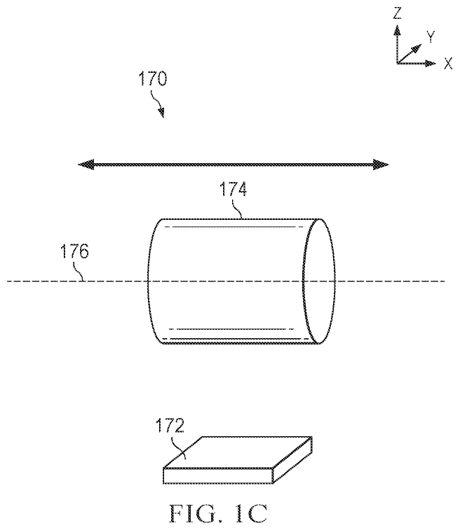

FIG. 1A is a schematic diagram of an on-axis position sensing system 110 that can include circuitries to support auto-calibration as to be described herein. On-axis position sensing system 110 can include a magnetic position sensor 112, which has a center aligned vertically to the center of a rotating diametric magnet 114. The center of magnetic position sensor 112 is also aligned with an axis of rotation 116. Magnetic position sensor 112 may include a semiconductor die having horizontal hall-effect elements to measure changing out-of-plane magnetic field (e.g., along the z-axis) due to rotation of the magnet, and the outputs of the horizontal hall-effect elements can be processed to compute the angle of rotation of the magnet 114. It will be appreciated that the magnetic position sensor 112 could be located along the axis 116 either above or below the magnet 114.

FIG. 1B is a schematic diagram of an off-axis position sensing system 150 that can include circuitries to support auto-calibration as to be described herein. Off-axis position sensing system 150 can include a magnetic position sensor 152, which is positioned at a periphery of a rotating diametric magnet 154 and away (e.g., non-coinciding) from an axis of rotation 156 of the magnet, as shown in FIG. 1B. Magnetic position sensor 152 may include a semiconductor die having vertical hall-effect elements to measure a changing in-plane magnetic field (e.g., along the x-axis and the y-axis) due to rotation of the magnet, and the outputs of the horizontal hall-effect elements can be processed to compute the angle of rotation of the magnet 154.

FIG. 1C is a schematic diagram of a linear position sensing system 170 that can include circuitries to support auto-calibration as to be described herein. Linear position sensing system 170 can include a magnetic position sensor 172. Magnetic position sensor 172 can measure the position (e.g., relative to magnetic position sensor 172) and/or linear movement of a magnet 174 along an axis 176. Magnetic position sensor 172 may include vertical hall-effect elements to measure a changing in-plane magnetic field (e.g., along the x-axis or the y-axis) and horizontal hall-effect elements to measure a changing out-of-plane magnetic field (e.g., along the z-axis) due to the movement of the magnetic, and the outputs of the horizontal hall-effect elements can be processed to determine the position and/or movement of the magnet 174.

As described above, each of magnetic position sensors 112, 152, and 172 can include multiple magnetic field sensors each including one or more hall-effect elements. Some of the magnetic field sensors are paired to sense magnetic fields having opposite directions and to generate differential signals (e.g., differential voltage signals) representing the difference between the opposite magnetic fields. Such arrangements can cancel out the stray magnetic field component in the differential signals and improve the accuracy of the position sensing. However, gain mismatches among the magnetic field sensors due to, for example, sensitivity mismatch and sensitivity drift associated with changes in temperature, stress, or humidity can lead to higher angular error drift, etc., can lead to incomplete cancellation of stray magnetic field component, which can degrade the position sensing accuracy. Also, to maximize/increase the differential signals, the distance between a pair of magnetic field sensors can be increased by, for example, placing the pair of hall-effect elements on opposite corners and/or edges of the semiconductor die. But due to the increased separation distance, the magnetic field sensors can be more prone to sensitivity mismatch and further increase the gain mismatches.

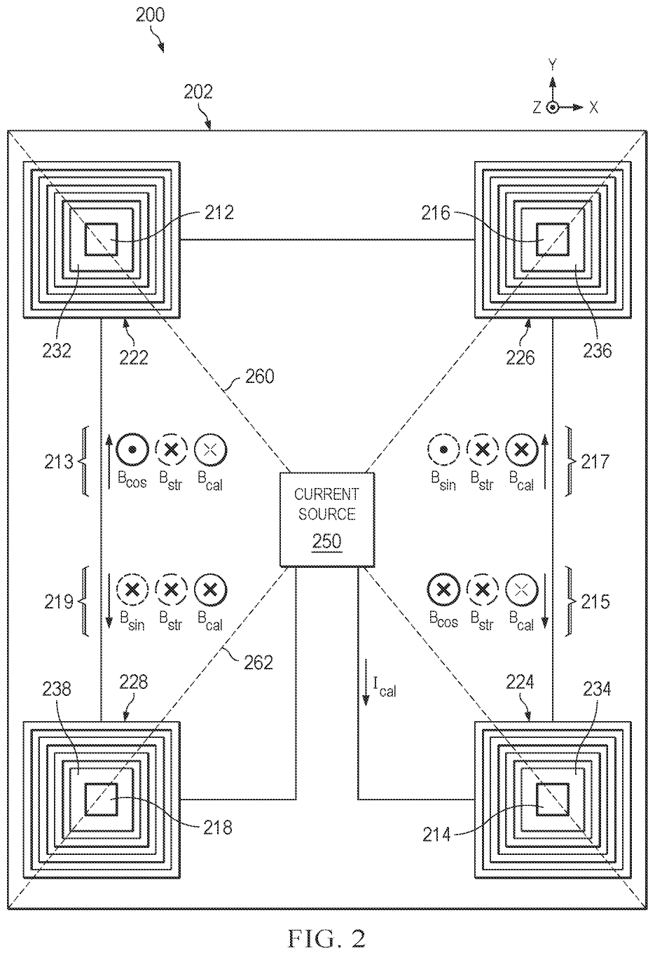

FIG. 2 is a top plan view of an example magnetic position sensor 200 that can address at least some of the issues described above. The magnetic position sensor 200 can include a semiconductor die 202 and one or more magnetic field sensor units 212, 214, 216, 218 formed on the die. For example, the magnetic position sensor 200 can include a first magnetic field sensor unit 212, a second magnetic field sensor unit 214, a third magnetic field sensor unit 216, and a fourth magnetic field sensor unit 218. Each magnetic field sensor unit 212, 214, 216, 218 can generate a corresponding sensor signal (e.g., a voltage) in response to a magnetic field measured by the respective magnetic field sensor units. For example, the first magnetic field sensor unit 212 can generate a first sensor signal in response to a magnetic field 213, the second magnetic field sensor unit 214 can generate a second sensor signal in response to a magnetic field 215, the third magnetic field sensor unit 216 can generate a third sensor signal in response to a magnetic field 217, and the fourth magnetic field sensor unit 218 can generate a fourth sensor signal in response to a magnetic field 219. Each of magnetic fields 213, 215, 217, and 219 can include a combination of multiple magnetic fields, such as an external magnetic field (represented by labels B_{cos} and Bₛᵢₙ), a stray magnetic field (represented by label Bₛₜᵣ), and a calibration magnetic field (labelled by B_{cal}) generated by magnetic position sensor 200 as to be described below. In the example shown in FIG. 2, the magnetic fields shown are at directions (e.g., along the z-axis) orthogonal to the surface of semiconductor die 202. In other examples, the magnetic fields can be parallel to the surface of semiconductor die 202 (e.g., along the x and y axes).

The first, second, third and fourth magnetic field sensor units 212, 214, 216 and 218 are spatially arranged apart from each other across a given surface of the semiconductor die 202. According to one example, the first magnetic field sensor unit 212 can be positioned on the given surface near a junction of intersecting side edges (e.g., a first corner) of the semiconductor die 202 and the second magnet field sensor unit 214 can be positioned on the given surface of the semiconductor die 202 near a junction of intersecting side edges (e.g., a second corner) opposing the first side. Also, the third and fourth magnetic field sensor units 216 and 218 can be on the same side of the semiconductor die 202 but at diametrically opposed corners from the first and second sensor units. For example, the first, second, third, and fourth sensor units can be positioned at or near corners of the semiconductor die 202. First and second magnetic field sensor units 212 and 214 can be a pair configured to measure first opposite external magnetic fields (B_{cos}) and generate differential signals representing a difference between the first opposite external magnetic fields. Also, third and fourth magnetic field sensor units 216 and 218 can be another pair configured to measure opposite second external magnetic fields (Bₛᵢₙ) and generate differential signals representing a difference between the second opposite external magnetic fields. To maximize the differential signals, the first and second sensor units 212 and 214 are spaced apart along a first diagonal axis 260 of the semiconductor die 202, and the third and fourth sensor units 216 and 218 are spaced apart along a second diagonal axis 262 of the semiconductor die 202.

The magnetic position sensor 200 can include one or more coils having one or more footprints overlapping the magnetic field sensor units 212, 214, 216, 218. The one or more of the coils can be formed on one or more metal layers on the die, and can have a square shape with right angled corners and/or chamfered corners. The one or more coils can also have other shapes, such as circular shape, oval shape, hexagonal shape, octagonal shape, etc. In FIG. 2, each coil can have multiple concentric windings. In the example of FIG. 2, the magnetic position sensor 200 includes a first coil 222 having a first footprint that overlaps the first magnetic field sensor unit, a second coil 224 having a second footprint that overlaps the second magnetic field sensor unit, a third coil 226 having a third footprint that overlaps the third magnetic field sensor unit, and a fourth coil 228 having a fourth footprint that overlaps the fourth magnetic field sensor unit. The first coil 222 and the second coil 224 can also be space apart along first diagonal axis 260, and the third coil 226 and the fourth coil 228 can also be spaced apart along second diagonal axis 262. Each of the respective coils 222, 224, 226 and 228 is coupled in series by electrical connections extending between pairs of the coils. The first coil 222 can surround a first core region 232, the second coil 224 can surround a second core region 234, the third coil 226 can surround a third core region 236, and the fourth coil 228 can surround a fourth core region 238. The footprint of a coil can include a spatial region or an area that the coil projects orthogonally onto die 202. The core region includes an area surrounded by the coil and regions directly below or above the area.

In the example of FIG. 2, the magnetic position sensor 200 can be part of the on-axis position sensing system 110 of FIG. 1A (e.g., magnetic position sensor 112), part of off-axis position sensing system 150 of FIG. 1B (e.g., magnetic position sensor 152), or part of linear position sensing system 170 of FIG. 1C (e.g., magnetic position sensor 172). Depending on the type of position sensor, each of magnetic field sensor units 212, 214, 216, 218 can have in-plane (vertical) or out-of-plane (horizontal) hall-effect elements, and the hall-effect elements can be in the core region (as shown in FIG. 2) or can be above or below the coil. The following table provides a summary of the type of hall-effect elements for each type of magnetic position sensor:

TABLE 1

| | On-axis position | Off-axis position | Linear position |
|---|---|---|---|
| | sensor | sensor | sensor |
| Sensor | Horizontal hall | Vertical hall - | Horizontal hall |
| unit 212 | (in core region 232) | measure x axis | (in core region 232) |
| | | (overlap coil 222) | |
| Sensor | Horizontal hall | Vertical hall - | Horizontal hall |
| unit 214 | (in core region 234) | measure x axis | (in core region 234) |
| | | (overlap coil 224) | |
| Sensor | Horizontal hall | Vertical hall - | Vertical hall - |
| unit 216 | (in core region 236) | measure x axis | measure x or y axes |
| | | (overlap coil 226) | (overlap coil 226) |
| Sensor | Horizontal hall | Vertical hall - | Vertical hall - |
| unit 218 | (in core region 238) | measure x axis | measure x or y axes |
| | | (overlap coil 228) | (overlap coil 228) |

As described herein, the coils 222, 224, 226 and 228 can be connected in series. For example, the first coil 222, the second coil 224, the third coil 226, and the fourth coil 228 can all be connected in series and coupled to a current source 250, which can be implemented on the semiconductor die 202. Also, or as an alternative, an input to one or more of the coils 222, 224, 226 and 228 can be coupled to an external current terminal, as described herein (see, e.g., FIG. 10). The current source 250 can be utilized to inject current (e.g., I_{cal}) for auto-calibration. For example, the injected auto-calibration current I_{cal} flows through the first coil 222, the second coil 224, the third coil 226, and the fourth coil 228 in series, and induces respective calibration magnetic fields B_{cal} for each magnetic field sensor unit 212, 214, 216, 218. In response to the respective induced calibration magnetic fields B_{cal}, each magnetic field sensor unit 212, 214, 216, 218 generates a corresponding sensor output (e.g., first sensor output, second sensor output, third sensor output, fourth sensor output, respectively) as a voltage. The auto-calibration current I_{cal} can be an alternating current (AC) signal, or a periodic signal having a frequency that is outside the frequency of rotation/movement to be sensed by the magnetic field sensor units. The calibration magnetic fields B_{cal} can have the same strength the first coil 222, the second coil 224, the third coil 226, and the fourth coil 228 due to the same current I_{cal} flowing through the coils. The direction of calibration magnetic fields B_{cal} can also be the same or opposite depending on the direction of flow of the calibration current I_{cal} through the coils.

As described herein, because the same current Ica is injected into each of the one or more coils 222, 224, 226 and 228, any errors associated with the calibration current (e.g., the amount of injected current is different from a target amount) can be cancelled out in a ratiometric manner, such as shown in Equation (1), and stray field rejection can be achieved to improve accuracy in corresponding position calculations. In other words, the series connection of all of the one or more coils (around single, dual, or quad Hall-effect sensors per magnetic field sensor unit) spread across the semiconductor die 202 ensures a matched calibration current even as headroom is lowered per coil. Specifically, the injected current (e.g., I_{cal}) for auto-calibration error or the gain error can be nullified inherently because a single current source can inject the same current to each of the coils 222, 224, 226 and 228.

As a further example, in an example where the magnetic position sensor 200 is an on-axis magnetic position sensor, B_{cos} and Bₛᵢₙ are external magnetic fields that are out-of-plane with respect to the hall-effect elements of the sensor units 212, 214, 216, and 218 and are related to the magnet field B generated by a rotary magnet (e.g., magnet 114) by the angular position θ and the trigonometric function (sine and cosine). For example, B_{cos} is related to the magnetic field B by cos(θ), and Bₛᵢₙ is related to the magnetic field B by sin(θ). The angular position θ can be computed from the sensed magnetic fields, as represented in the sensor output voltages, such as set forth in Equations (1) through (5):

$${V}_{1} = {G}_{1} ( - {B}_{c o s} + {B}_{str} + {B}_{c a l} ) \qquad ( 1 )$$

$${V}_{2} = {G}_{2} ( {B}_{c o s} + {B}_{str} + {B}_{c a l} ) \qquad ( 2 )$$

$${V}_{3} = {G}_{3} ( - {B}_{s i n} + {B}_{str} + {B}_{c a l} ) \qquad ( 3 )$$

$${V}_{4} = {G}_{4} ( {B}_{s i n} + {B}_{str} + {B}_{c a l} ) \qquad ( 4 )$$

$$θ = atan 2 ( \frac{{B}_{s i n +} - {B}_{s i n -}}{{B}_{c o s +} - {B}_{c o s -}} ) \qquad ( 5 )$$

In Equations 1-4, G₁ represents a gain (or a sensitivity factor) of sensor unit 212 in converting a sensed magnetic field to a sensor output voltage, and V₁ represents voltage output by the sensor unit 212. G₂ represents a gain (or a sensitivity factor) of sensor unit 214 in converting a sensed magnetic field to a sensor output voltage, and V₂ represents voltage output by the sensor unit 214. G₃ represents a gain (or a sensitivity factor) of sensor unit 216 in converting a sensed magnetic field to a sensor output voltage, and V₃ represents voltage output by the sensor unit 216. G₄ represents a gain (or a sensitivity factor) of sensor unit 218 in converting a sensed magnetic field to a sensor output voltage, and V₄ represents voltage output by the sensor unit 218.

In a case where magnetic positions sensor 200 is an off-axis magnetic position sensor, sensor units 212, 214, 216, and 218 can include in-plane hall-effect elements to measure magnetic fields Bₓ₁, Bₓ₃, B_{y1}, and B_{y3} on the x-y plane, and the angular position θ can be computed from the sensed magnetic fields, as represented in the sensor output voltages, based on the following Equation (6):

$$θ = atan 2 ( \frac{{B}_{y 3} - {B}_{y 1}}{{B}_{x 3} - {B}_{x 1}} ) \qquad ( 6 )$$

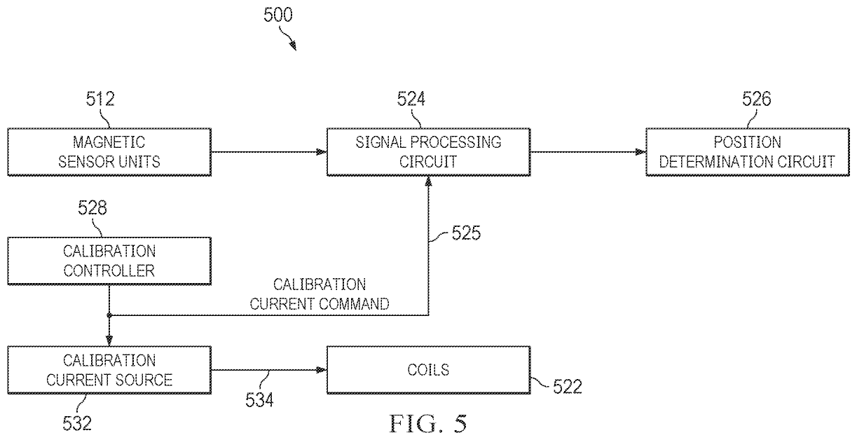

A calibration factor can be computed (e.g., by the signal processing circuit of FIG. 5) for each magnetic field sensor unit 212, 214, 216, 218 based on I_{cal} and the resulting calibration magnetic field B_{cal}, which is sensed by the respective sensor units. In this way, the respective calibration factors (or gains G₁, G₂, G₃, and G₄) can be determined for magnetic field sensor unit 212, 214, 216, 218 to implement gain correction for each magnetic field sensor unit 212, 214, 216, 218. The gain correction thus can be implemented during operation (e.g., continuously or periodically) to provide an auto-calibration function for the magnetic position sensor 200. By adjusting the gains, the voltage components representing the stray magnetic field Bₛₜᵣ can be cancelled in the difference between V₁ and V₂, and in the difference between V₃ and V₄, hence stray field immunization can be achieved.

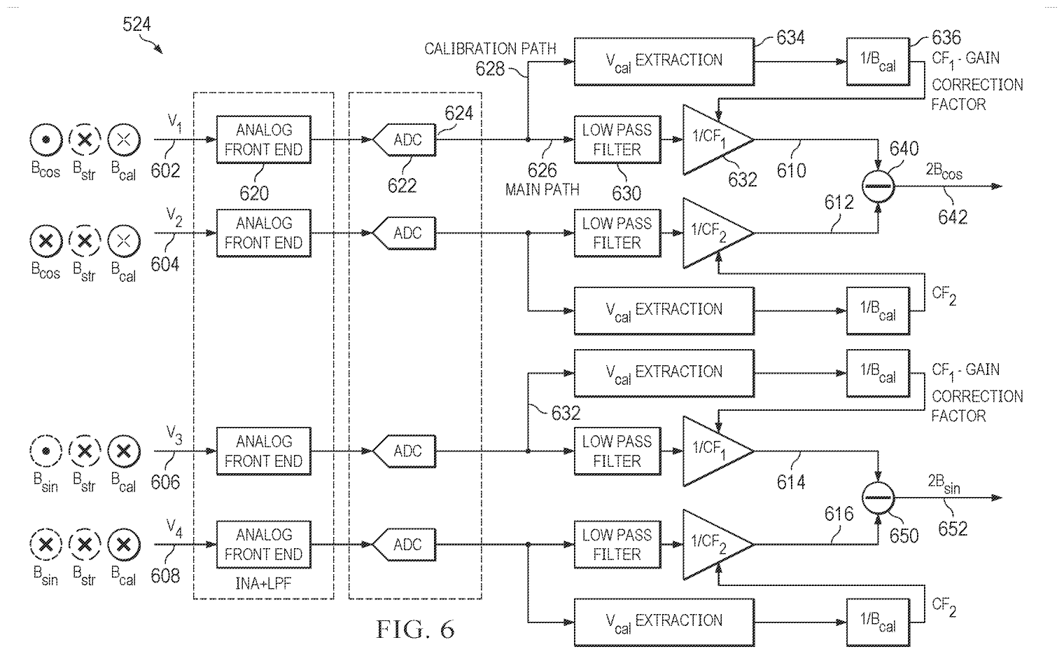

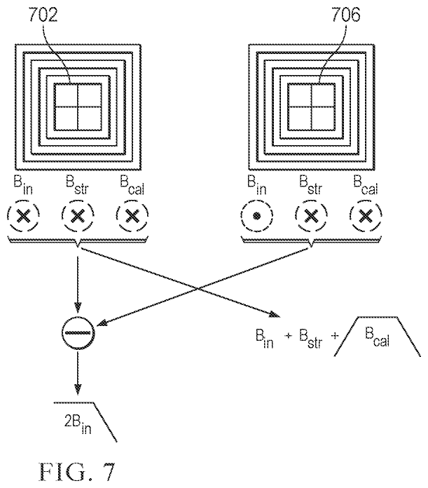

As a further example, in response to the calibration current I_{cal} being applied to the one or more coils 222, 224, 226, 228, the magnetic field sensor units 212, 214, 216, 218 can generate one or more corresponding sensor signals (e.g., a first sensor signal, a second sensor signal, a third sensor signal, and a fourth sensor signal) and transmit these sensor signals to a signal processing circuit (see, e.g., FIGS. 5-6). The first sensor signal can represent one or more first magnetic fields 213 detected by the first magnetic field sensor unit 212, the second sensor signal can represent one or more second magnetic fields 215 detected by the second magnetic field sensor unit 214, the third sensor signal can represent one or more third magnetic fields 217 detected by the third magnetic field sensor unit 216, the fourth sensor signal can represent one or more fourth magnetic fields 219 detected by the fourth magnetic field sensor unit 218.

As described herein, each of the sensor signals can represent one or more magnetic fields detected at each respective magnetic field sensor unit 212, 214, 216, 218. Examples of one or more of the magnetic fields can include a calibration magnetic field B_{cal} induced by the calibration current I_{cal}, a stray magnetic field Bₛₜᵣ which is common across the semiconductor die 202, and either a time-varying magnetic field (Bₛᵢₙ, B_{cos}, Bₓ₁, Bₓ₃, B_{y1}, B_{y3}) responsive to the field provided by the object (e.g., a magnet) for which position is to be determined.

Thus, the first sensor signal can represent the one or more calibration magnetic fields and a first external magnetic field (e.g., one of Bₛᵢₙ, B_{cos}, Bₓ₁, Bₓ₃, B_{y1}, B_{y3}), the second sensor signal can represent the one or more calibration magnetic fields and a second magnetic field (e.g., one of Bₛᵢₙ, B_{cos}, Bₓ₁, Bₓ₃, B_{y1}, B_{y3}), the third sensor signal can represent the one or more calibration magnetic fields and a third external magnetic field (e.g., one of Bₛᵢₙ, B_{cos}, Bₓ₁, Bₓ₃, B_{y1}, B_{y3}), the fourth sensor signal can represent the one or more calibration magnetic fields and a fourth external magnetic field (e.g., one of Bₛᵢₙ, B_{cos}, Bₓ₁, Bₓ₃, B_{y1}, B_{y3}). Because the same current is injected into all of the coils 222, 224, 226, 228, any errors associated with the calibration current I_{cal} is cancelled out based on the ratiometric set of Equations (1)-(6) and may not appear as error components in the differential signals provided by the sensor units.

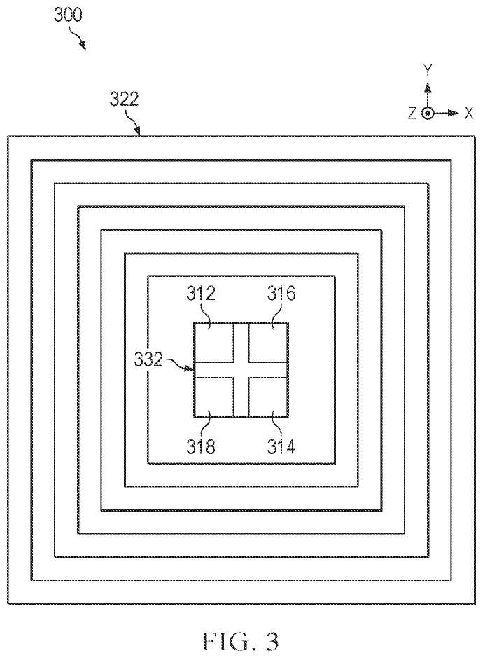

FIG. 3 is a top plan view of an example magnetic field sensor unit 300 of a magnetic position sensor. The magnetic field sensor unit 300 can be part of the magnetic field sensor units 212, 214, 216, 218 of FIG. 2. The example magnetic field sensor unit 300 of FIG. 3 includes four Hall-effect elements (e.g., sensors) 312, 314, 316, 318 at respective corners of the magnetic field sensor unit 300 and includes coil 322 having a footprint that overlaps the magnetic field sensor unit 300 and surrounding a core region 332 thereof that encompasses the Hall-effect elements 312, 314, 316, 318. It will be appreciated that any number (e.g., 1, 2, 4, etc.) of Hall-effect elements can be implemented on the magnetic field sensor unit 300.

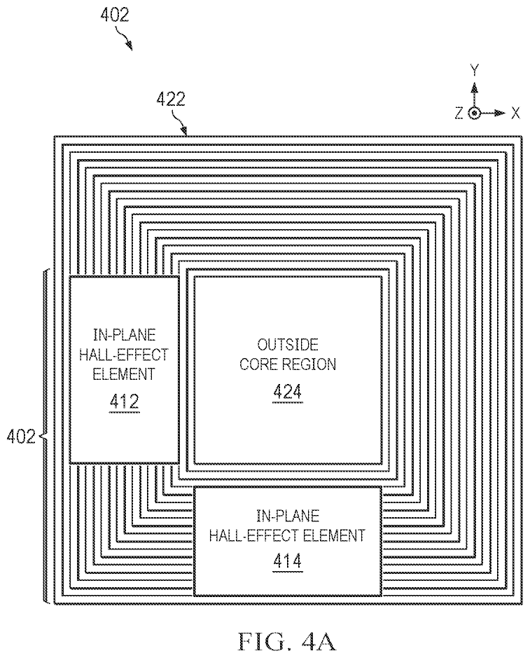

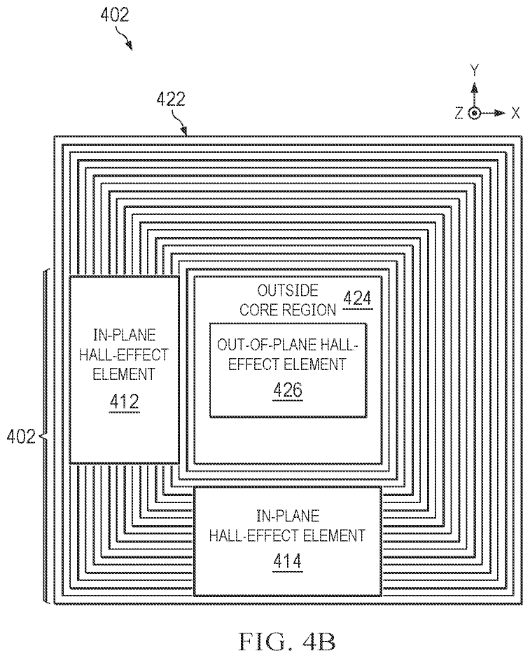

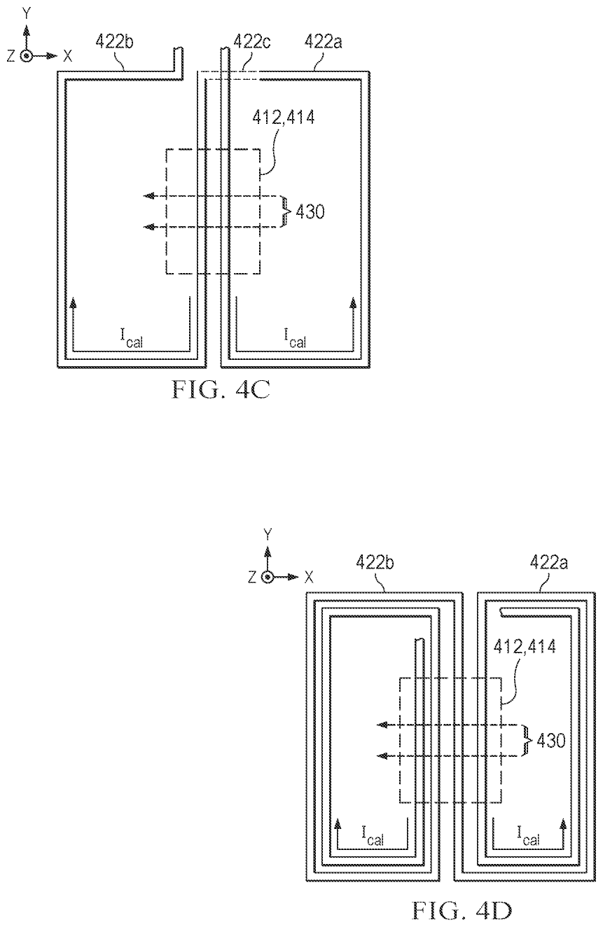

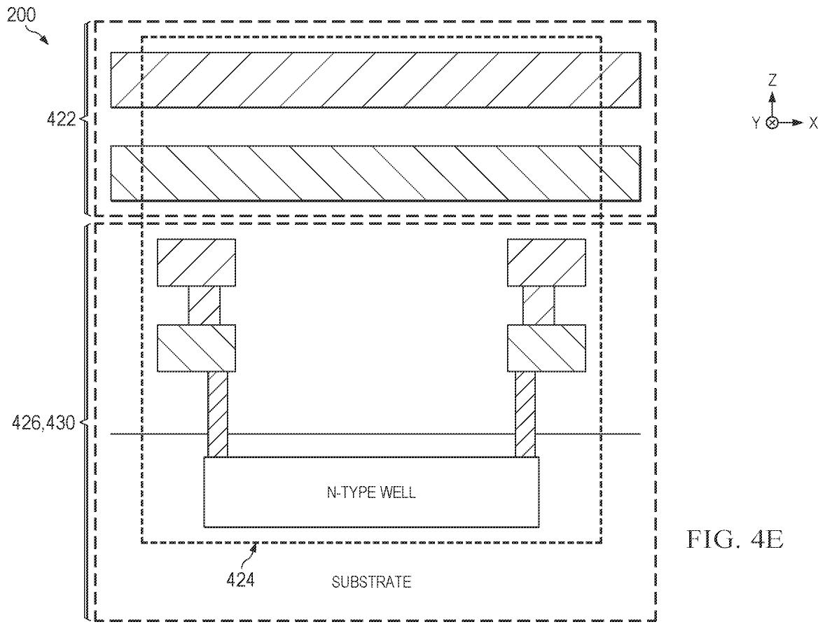

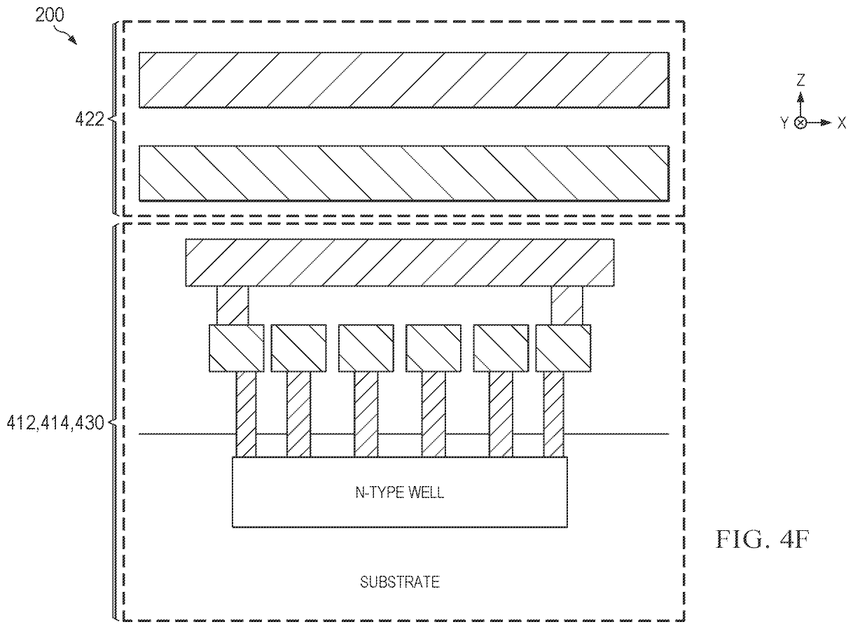

FIG. 4A is a top plan view of another example magnetic field sensor unit 402 and coil 422, which can be part of the magnetic position sensor 200. Magnetic field sensor unit 402 and coil 422 can be part of an off-axis magnetic position sensor and includes in-plane hall-effect elements 412 and 414 that overlap with coil 422 and outside core region 424. In some examples, hall-effect element 412 can be configured to sense a magnetic field (e.g., a combination of a calibration magnetic field generated by coil 422 and an external magnetic field) along the x-axis, and hall-effect element 414 can be configured to sense another magnetic field (e.g., a combination of a calibration magnetic field generated by coil 422 and another external magnetic field) along the y-axis.

FIG. 4B is a top plan view of another example magnetic field sensor unit 402 and coil 422, which can be part of the magnetic position sensor 200. Magnetic field sensor unit 402 and coil 422 can be part of a magnetic linear position sensor and includes in-plane hall-effect elements 412 and 414 that overlap with coil 422 and outside core region 424, and out-of-plane hall-effect element 426 in core region 424. Hall-effect element 426 can sense a magnetic field (e.g., a combination of a calibration magnetic field generated by coil 422 and an external magnetic field) along the z-axis. The arrangement of FIG. 4B allows generation of both in-plane and out-of-plane calibration magnetic fields for calibrating magnetic field sensor unit 402 including both in-plane and out-of-plane hall-effect elements.

FIGS. 4C are 4D are top plan views of additional examples of magnetic field sensor unit 402 and coil 422. Referring to FIG. 4C and FIG. 4D, coil 422 can include two windings 422a and 422b that are not concentric. In FIG. 4C, windings 422a and 422b are connected by an underpass portion 422c to allow the calibration current I_{cal} to flow from winding 422a to winding 422b. In FIG. 4C, calibration current I_{cal} can flow in a counter-clockwise direction in winding 422a and in a clockwise direction in winding 422b. Magnetic field sensor unit 402 can include in-plane hall-effect elements 412/414 below part of windings 422a and 422b to sense in-plane calibration magnetic fields 430 (e.g., along the x/y axes).

FIGS. 4E and 4F are cross-sectional views of example magnetic position sensors, such as magnetic position sensor 200 including magnetic field sensor unit 402 and coil 422. The example of FIG. 4E can include an out-of-plane hall-effect element, such as hall-effect element 426. As shown in FIG. 4E, sensor 400 includes the coil 422 formed in a metal layer. The coil(s) 422 have a footprint that overlaps (e.g., surrounds) the hall-effect elements, such as residing within a polysilicon layer beneath the coils. In the example of FIG. 4E, the coil 422 does not overlap the hall-effect element 426, and hall-effect element 426 is in the core region 424. The die also includes circuitry 430 formed within the die, which can perform position sensing functions described herein. FIG. 4F illustrates an example magnetic position sensor 200 having an in-plane hall-effect element, such as hall-effect elements 412 and 414, directly below (and overlap with) coil 422.

FIG. 5 is a block diagram of an example system 500 for magnetic position detection. The system 500 can include one or more magnetic field sensor units 512, one or more corresponding coils 522, a signal processing circuit 524, a position determination circuit 526, a calibration controller 528, and a calibration current source 532. System 500 can be part of circuitry 430. In some examples, system 500 can be part of an application specific integrated circuit (ASIC). Various components of system 500, such as calibration controller 528, signal processing circuit 524 and position determination circuit 526, can be implemented based on digital logic circuits, or can be implemented as software modules, which are then executed by a processor to perform the functions of calibration controller 528, signal processing circuit 524, and position determination circuit 526 as to be described herein.

As shown in FIG. 5, the signal processing circuit 524 can have one or more inputs coupled to respective outputs of the magnetic field sensor units 512. For example, the signal processing circuit 524 can have a first sensor input coupled to a first sensor output of the first magnetic field sensor unit, a second sensor input coupled to a second sensor output of the second magnetic field sensor unit, a third sensor input coupled to a third sensor output of the third magnetic field sensor unit, and a fourth sensor input coupled to a fourth sensor output of the fourth magnetic field sensor unit, similarly to FIG. 2.

The signal processing circuit 524 can have a command terminal 525 connected to an output of the calibration controller 528. The command terminal 525 can also be coupled to a control input of the calibration current source 532. The calibration controller 528 can be configured to provide a calibration current command at 525 to control the calibration current source 532 to provide calibration current to the one or more coils 522 through an input current terminal 534, which is coupled to the one or more coils 522. The calibration controller 528 thus can control the calibration current source 532 to apply the calibration current to the one or more coils 522 based on the calibration current command. In this way, the system 500 can provide the calibration current through the one or more coils 522 via the current terminal to cause the one or more coils 522 to generate respective calibration magnetic fields to be applied to the respective magnetic field sensor units 512.

In response to the calibration current being applied to the one or more coils 522, the magnetic field sensor units 512 can generate respective sensor signals representative of the detected magnetic fields and provide the sensor signals to the signal processing circuit 524. As described herein (see, e.g., Equations 1-6), each of the sensor signals can represent multiple magnetic field components. For example, the signal processing circuit 524 can receive a first sensor signal at the first sensor input, a second sensor signal at the second sensor input, a third sensor signal at the third sensor input, and a fourth sensor signal at the fourth sensor input. The first sensor signal can represent the one or more calibration magnetic fields and a first external magnetic field (e.g., one of Bₛᵢₙ, B_{cos}, Bₓ₁, Bₓ₃, B_{y1}, B_{y3}), the second sensor signal can represent the one or more calibration magnetic fields and a second magnetic field (e.g., one of Bₛᵢₙ, B_{cos}, Bₓ₁, Bₓ₃, B_{y1}, B_{y3}), the third sensor signal can represent the one or more calibration magnetic fields and a third external magnetic field (e.g., one of Bₛᵢₙ, B_{cos}, Bₓ₁, Bₓ₃, B_{y1}, B_{y3}), the fourth sensor signal can represent the one or more calibration magnetic fields and a fourth external magnetic field (e.g., one of Bₛᵢₙ, B_{cos}, Bₓ₁, Bₓ₃, B_{y1}, B_{y3}). Each of the sensor signals can also include a component of common stray magnetic field (Bₛₜᵣ) sensed by each respective magnetic sensor unit 512.

The signal processing circuit 524 can be configured to determine a calibration factor for each of the first, second, third, and fourth magnetic field sensor units based on the first, second, third, and fourth sensor signals, respectively. The signal processing circuit 524 can apply the calibration factor determined for each magnetic field sensor unit 512 to adjust a gain for the respective sensor unit. The one or more gains can include the first gain of the first magnetic field sensor, the second gain of the second magnetic field sensor, the third gain of the third magnetic field sensor, and the fourth gain of the fourth magnetic field sensor. The calibration factor can be determined and remain static or it can be determined during operation (e.g., continuously or intermittently).

The signal processing circuit 524 can in turn generate an output signal at a sensing output based on respective adjusted gains of the first, second, third, and fourth magnetic field sensor units. The output signal can represent the detected angular/linear position. In one example, the one or more gains include the average gain of the first and second magnetic field sensor units. In another example, the one or more gains include the average gain of the first, second, third, and fourth magnetic field sensor units. The position determination circuit 526 can utilize the output signal to compute an angle, such as shown in Equation 5.

FIG. 6 is a block diagram of an example signal processing circuit 524 that can be implemented for a multi-channel magnetic position detection circuit. For example, the signal processing circuit 524 of FIG. 6 is an example of the signal processing circuit 524 of FIG. 5. Accordingly, the description of FIG. 6 can refer to the description of FIG. 5. In the example of FIG. 6, an example of on-axis position sensing is illustrated, where external out-of-plane magnetic fields +B_{cos} (pointing out of paper), −B_{cos} (pointing into paper), +Bₛᵢₙ (pointing out of paper), and −Bₛᵢₙ (pointing into paper) are sensed. In some examples, the signal processing circuit 524 of FIG. 6 can provide off-axis sensing, where +/−B_{cos} can be replaced by in-plane magnetic fields +/−Bₓ and +/−Bₛᵢₙ can be replaced by in-plane magnetic fields +/−B_{y}. Also, in some examples, the signal processing circuit 524 of FIG. 6 can provide linear position sensing, where one of +/−B_{cos} or +/−Bₛᵢₙ can be replaced by in-plane magnetic fields +/−Bₓ or +/−B_{y}.

The signal processing circuit 524 includes a respective signal path (also referred to as a signal chain) for each magnetic field sensor unit, which each path includes a main path and calibration path. Each signal path has a respective input 602, 604, 606 and 608 and a respective output 610, 612, 614 and 616. For example, a first signal path has an analog front end (AFE) 620 having its input 602 coupled to a sensor unit output to receive sensor signal voltage V1. The AFE 620 can include an input amplifier and a filter circuit (e.g., a low pass filter) to provide an analog output to an input of an analog-to-digital converter (ADC) 622. The ADC 622 can convert the analog output to a corresponding digital signal at an ADC output 624, which is provided for processing by a main processing path 626 and a calibration processing path 628. The processing paths 626 and 628 can be on the same die as the magnetic field sensor units or different circuitry (e.g., on a printed circuit board). In some examples, the signal processing circuit 524 may include one set of AFE and ADC that can be shared between different magnetic sensor units.

The main processing path 626 includes a low pass filter 630 and a gain stage 632. The low pass filter can filter the digital signal at 624 (e.g., an amplified and filtered digital version of V1) and provide a corresponding digital filtered signal to an input of the gain stage 632. The gain stage 632 amplifies the corresponding digital filtered signal based on a variable gain thereof, which is corrected by the calibration processing path 628, to provide an output representative of a measured magnetic field.

The calibration processing path 628 includes an extraction circuit 634 and calibration correction factor circuit 636. The extraction circuit 634 can extract a measure of the calibration magnetic field from the digital signal at 624 (e.g., an amplified and filtered digital version of V₁). For example, the extraction circuit 634 can extract the calibration field using at least one of a bandpass filter, a root mean square (RMS) operation, an auto-correlation operation, or a Fourier transform operation. The extracted calibration field represents the component of V₁ responsive to the injected calibration current that is sensed by the first sensor unit. As described herein, the calibration current can be injected once, continuously or intermittently, and can have a frequency that is outside the frequency of rotation/movement to be sensed by the magnetic sensor units. Accordingly, the calibration magnetic field component of V₁ (V_{cal1}) and the external magnetic field component of V₁ can have different frequency bands and/or have different frequency signatures, based on which the extraction circuit 634 can separate out the calibration magnetic field and external magnetic field components.

The calibration correction factor calculator 636 can compute a gain correction factor CF₁ based on the extracted calibration signal (e.g., provided by the extraction circuit 634). The gain correction factor CF₁ is applied to the gain stage 632 to set the gain for the respective first signal processing path, which provides a gain corrected measurement of the sensed magnetic field at the signal path output 610.

Each of the other signal processing paths can be configured the same as the first signal processing path and thus configured to set an individual gain for each respective signal processing path based on the magnetic field sensor output signals V₂, V₃, and V₄. That is, each signal processing path of the signal processing circuit 524 can extract a calibration voltage V_{cal} (e.g., V_{cal1}, V_{cal2}, V_{cal3}, V_{cal4}) associated with each one of the first, second, third, and fourth sensor signals V₁, V₂, V₃, V₄ by processing performed in its respective calibration path. The signal processing circuit 524 can be further configured to calculate a corresponding gain correction factor CF (e.g., CF₁, CF₂, CF₃, CF₄) for each of the magnetic field sensor units 212, 214, 216, 218, respectively. The gain correction factor can be based on, for example, the calibration voltage (one of V_{cal1}, V_{cal2}, V_{cal3}, V_{cal4}) extracted for a particular magnetic field sensor unit and the calibration magnetic field, which can be determined based on the known calibration current I_{cal}. Thus, each signal processing path can provide a respective gain-corrected magnetic field measurement at the respective path output thereof 610, 612, 614 and 616. It will be appreciated that the signal processing circuit 524 can be configured to operate in a time-interleaved fashion to allow for passive or active calculation of gains and/or gain correction factors.

Further, the signals provided at 610, 612, 614 and 616 by each signal processing path of the signal processing circuit 524 represent gain-corrected versions of the processed magnetic field signal measurement, each include gain corrected magnetic field components for the field measured from the object (e.g., rotating magnet), stray field components and calibration components. For example, the gain-corrected magnetic field signal measurement for the first magnetic field sensor at 610 can be represented as:

$$\frac{{k}_{1} {G}_{1}}{C {F}_{1}} ( - {B}_{c o s} + {B}_{str} + {B}_{c a l} ) \qquad ( 7 )$$

In Equation (7), k₁ is a constant associated with the coil design of the first magnetic field sensor, G₁/CF₁ is the calibrated gain implemented at the gain stage 632.

Also, the second signal path provides a gain-corrected field signal measurement for the second magnetic field sensor at 612, which can be represented as:

$$\frac{{k}_{2} {G}_{2}}{C {F}_{2}} ( {B}_{c o s} + {B}_{str} + {B}_{c a l} ) \qquad ( 8 )$$

In Equation (8), k₂ is a constant associated with the coil of the second magnetic field sensor, G₂/CF₂ is the calibrated gain for the respective gain stage. The signals at 610 and 612 can be combined (e.g., by subtraction function 640) to provide an output at 642 equal to 2B_{cos}, which can be determined as follows:

$$\frac{{k}_{2} {G}_{2}}{C {F}_{2}} ( {B}_{c o s} + {B}_{str} + {B}_{c a l} ) - \frac{{k}_{1} {G}_{1}}{C {F}_{1}} ( - {B}_{c o s} + {B}_{str} + {B}_{c a l} ) = 2 {B}_{c o s} \qquad ( 9 )$$

The signal processing paths for input sensor voltages V₃ and V₄, which are provided by the third and fourth magnetic field sensor units, can be configured the same to provide respective gain-corrected magnetic field signal measurements at 614 and 616. The gain-corrected magnetic field signal measurements at 614 and 616 are combined (e.g., by subtraction function 650) to provide an output at 652 equal to 2Bₛᵢₙ. Advantageously, the stray magnetic field components can be cancelled when the outputs of respective pairs of paths are combined (e.g., by subtraction function 642 and 652). The calibration field components, which are representative of the induced field responsive to the calibration current, can be removed from the signal by including a filter (e.g., low pass filter) in the signal path. The signal processing circuit 524 can be configured to generate the position output signal based on combined outputs (e.g., 2B_{cos} and 2Bₛᵢₙ, B_{y3}−B_{y}, and Bₓ₃−Bₓ₁, etc.), representative of the sensed position, such as an angle θ (see, e.g., Equations 5 and 6) and/or the linear position.

The systems and methods described herein can be implemented to provide for calibration (e.g., automatic calibration) of each respective signal path can be used with other configurations of magnetic field sensor units implemented in a magnetic position sensor. FIGS. 7-9 are illustrations of different example magnetic field sensor configurations that can implement the auto-calibration techniques described herein. For example, FIG. 7 shows the signal chains for a pair of magnetic field sensor units 702 and 704, such as sensor units 212 and 214. As shown in FIG. 7, each sensor unit produces a voltage that includes components for the main input field component Bᵢₙ, stray field component Bₛₜᵣ, and calibration field component B_{cal}. By signal processing and subtraction of the processed signals, the differential signals representing a difference between the opposite external magnetic fields, shown as 2Bᵢₙ, can be determined. The stray field component is common in the differential signals and can be cancelled, and the calibration field components can be isolated and used for autocalibration of signal chain gain, such as described herein. The calibration field component can also be removed from the signal chain (e.g., by filtering). The example configuration of FIG. 7 allows determining the gain (or gain correction factor) for each magnetic sensor unit individually, and the calibration operation can be more effective in removing the gain error between the pair of magnetic field sensor units.

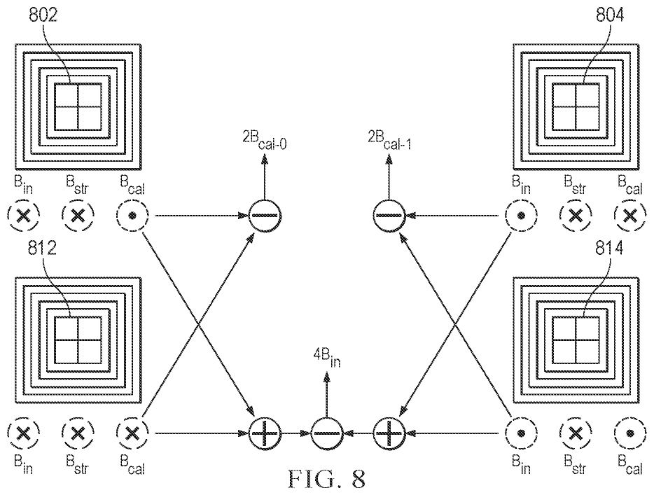

FIG. 8 shows another example of calibration signal chain for magnetic field sensor units. As shown in FIG. 8 each sensor unit provides a respective signal, which includes components for the main input field component Bᵢₙ, stray field component Bₛₜᵣ, and calibration field component B_{cal}. Sensor units 802 and 804 can sense opposite external magnetic fields Bᵢₙ and opposite calibration magnetic fields B_{cal}. Also, sensor units 812 and 814 can sense opposite external magnetic fields Bᵢₙ and opposite calibration magnetic fields B_{cal}. Sensor units 802 and 812 can sense external magnetic fields Bᵢₙ in a same first direction and opposite calibration magnetic fields B_{cal}. Sensor units 804 and 814 can sense external magnetic fields Bᵢₙ in a same second direction (opposite from the first direction) and opposite calibration magnetic fields B_{cal}.

In FIG. 8, the sensor signals output by sensor units 802 and 812 can be subtracted to extract a calibration magnetic field component shown as 2B_{cal-0}. The sensor signals output by sensor units 804 and 814 can also be subtracted to extract a calibration magnetic field component shown as 2B_{cal-1}. The calibration magnetic field components 2B_{cal-0} and 2B_{cal-1} can be used for autocalibration of signal chain gain, such as described herein. For example, 2B_{cal-0} can be used to generate an average gain correction factor for sensor units 802 and 812, and 2B_{cal-1} can be used to generate an average gain correction factor for sensor units 804 and 814. Also, the sensor signals provided by sensor units 802 and 812 can be summed, the sensor signals provided by sensor units 804 and 814 can also be summed, the a difference can be determined between the sum of sensor signals from sensor units 802/812 and the sum of sensor signals from sensor units 804/814. The difference, shown as 4Bᵢₙ (or 2Bₛᵢₙ and 2B_{cos} for on-axis sensing, Bₓ₁−Bₓ₃ and B_{y1}−B_{y3} for off-axis sensing) can represent the external magnetic field with stray magnetic field (Bₛₜᵣ) and calibration magnetic field (B_{cal}) components removed, and can be used for position sensing. The arrangements of FIG. 8 can reduce the complexity of operations involved in the extraction of the calibration component magnetic field components and the computation of the gain factor.

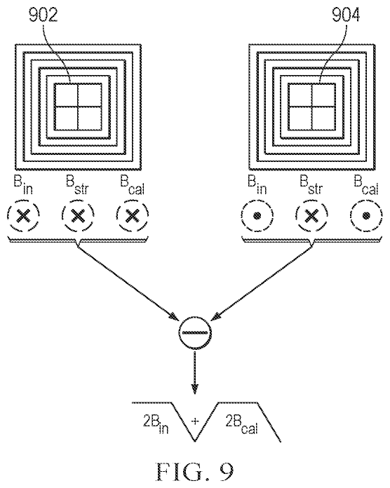

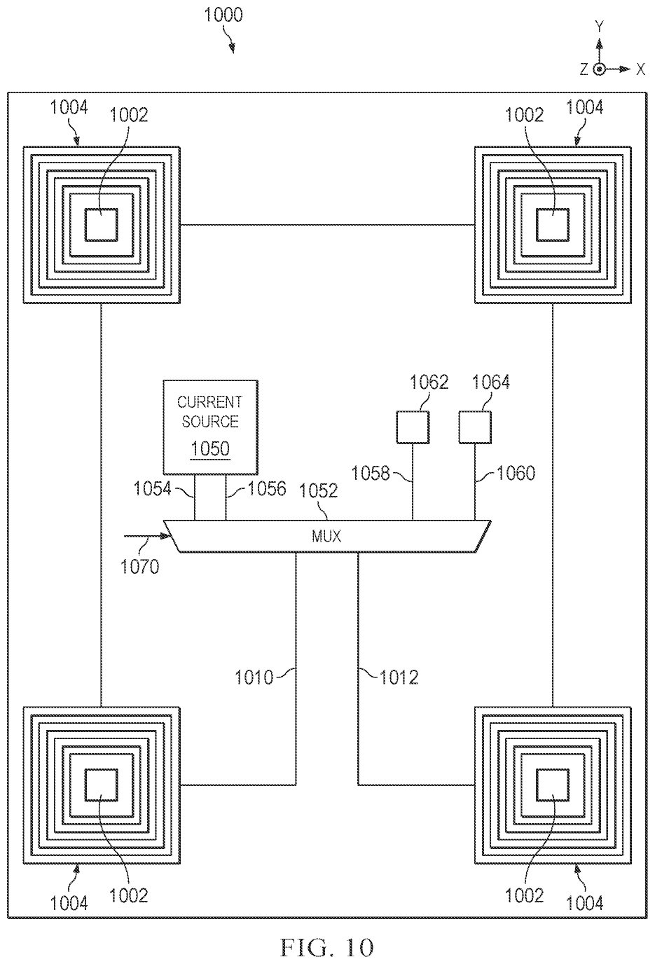

FIG. 9 shows another example signal chain for magnetic field sensor units. As shown in FIG. 9, each of sensor units 902 and 904 produces a voltage that includes components for the external magnetic field component Bᵢₙ, stray field component Bst-, and calibration magnetic field component B_{cal}. The sensor units 902 and 904 sense opposite external magnet fields and opposite calibration magnetic fields. The signals from the sensor units can be subtracted to remove the stray field component and provide the components for the main input signal and the calibration component, shown as 2Bᵢₙ+2Bcal. The calibration field components can be isolated and used for autocalibration of signal chain gain, such as described herein, to determine an average gain correction factor for sensor units 902 and 904. The arrangements of FIG. 9 can reduce the complexity of operations involved in the extraction of the calibration component magnetic field components and the computation of the gain factor.

FIG. 10 is a top plan view of an example integrated circuit (IC) 1000 of a magnetic position sensing system. As shown in FIG. 10, the IC 1000 includes a plurality of magnetic field sensor units 1002, each of which can have a number of one or more magnetic field sensors (e.g., Hall-effect sensors), such as described herein (see, e.g., FIG. 3). The IC 1000 also includes one or more coils 1004 having one or more respective footprints overlapping the sensor units 1002. In the example of FIG. 10, a respective coil overlies each sensor unit, and the coils are connected in series between a current input and output, shown at 1010 and 1012.

The IC 1000 can include an on-chip current source 1050. The current source can be configured to inject a calibration current to the series-connected arrangement of one or more coils 1004, such as described herein. In the example of FIG. 10, the IC also includes a multiplex (MUX) 1052. The MUX 1052 has inputs 1054 and 1056 coupled to respective outputs of the current source 1050. The MUX 1052 also has inputs 1058 and 1060 coupled to terminals 1062 and 1604, respectively. The terminals 1062 and 1064 can be implemented as electrically conductive pads or pins arranged and configured to enable external circuitry access to the inputs 1058 and 1060, directly or indirectly through other circuitry. The MUX 1052 can select which input or inputs are electrically connected to the current input and output 1010 and 1012 in response to a selection signal provided to a control input 1070 of the MUX 1052. For example, the MUX 1052 can switch between the on-chip current source 1050 or an external current source (not shown), which has its outputs coupled to the terminals 1062 and 1064. The MUX 1052 can select the on-chip current source 1050 in a first scenario to inject a calibration current to the coils in response to a selection signal at 1070, such a provided by a calibration controller (e.g., calibration controller 528 from FIG. 5). In another example, the MUX can select the inputs 1058 and 1060 while one or more external current terminal(s) 1060 is coupled to the terminals 1062 and 1604 to provide current for the one or more coils in a second scenario based on a signal provided to the MUX to enable external current to be applied to the coils 1004. In an example, an external current source can be connected to terminals 1062 and 1064 to provide an external current to the coils as part of a trimming process, in which one or more fuses or register entries can be set during wafer and/bench testing of the IC 1000. That is, the coils 1004 described herein can serve multiple purposes, namely, to implement calibration during operation as well as to perform trimming during device testing.

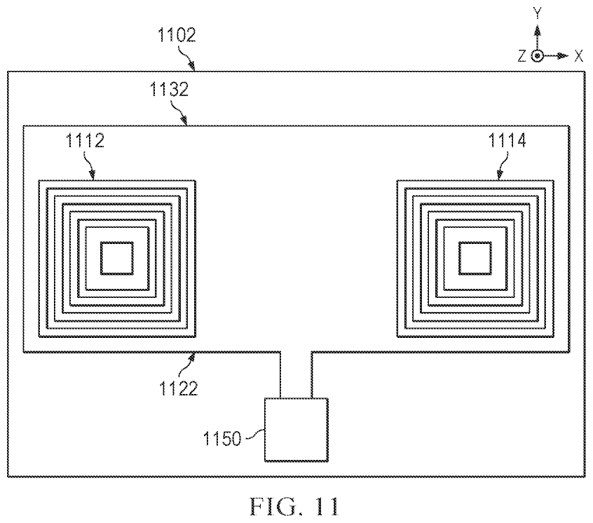

FIG. 11 is a top plan view of another example semiconductor die 1102 of a magnetic position sensor configured to implement auto-calibration. Semiconductor die 1102 can be an example of semiconductor die 202 and can include a single coil 1122 and magnetic field sensor units 1112, 1114. The single coil 1122 has a single footprint that overlaps multiple magnetic field sensor units 1112, 1114 (e.g., first and second magnetic field sensor units), according to one example. In an example where the position sensing system is on-axis (e.g., the magnetic position sensor is configured as shown in FIG. 1A), the single coil 1122 can surround a core region 1132. The first and second magnetic field sensor units 1112, 1114 can be in core region 1132 (as shown in FIG. 11) in an on-axis position sensor, or can overlap with coil 1122 in an off-axis position sensor.

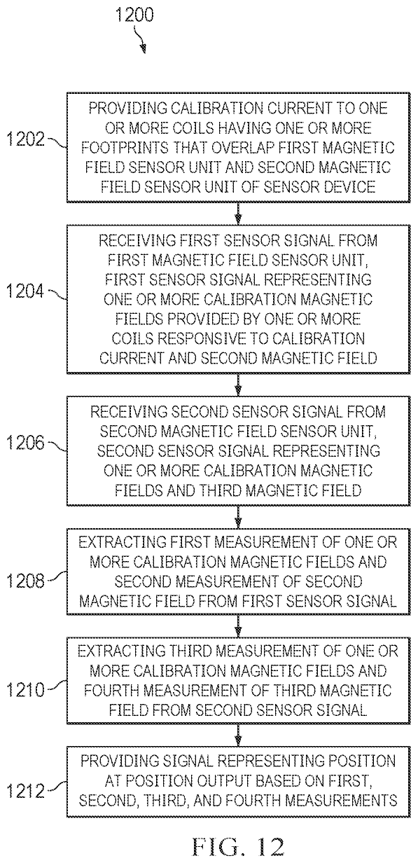

FIG. 12 is an example method 1200 for magnetic position sensing with single source auto-calibration. The method 1200 can include providing 1202 a calibration current to one or more coils having one or more footprints that overlap a first magnetic field sensor unit and a second magnetic field sensor unit of a sensor device. For example, the providing of the calibration current can be implemented by the calibration controller 528 enabling the calibration current source 532 to inject current to one or more coils, such as described herein. The method 1200 can include receiving 1204 a first sensor signal from the first magnetic field sensor unit. The first sensor signal can represent one or more calibration magnetic fields provided by the one or more coils responsive to the calibration current and a second magnetic field. The method 1200 can also include receiving 1206 a second sensor signal from the second magnetic field sensor unit, in which the second sensor signal represents the one or more calibration magnetic fields and a third magnetic field. For example, the first and second sensor signals can be received by the signal processing circuit 524, based on sensor signals provided by one or more sensor units, such as described herein. The method 1200 can include extracting 1208 a first measurement of the one or more calibration magnetic fields and a second measurement of the second magnetic field from the first sensor signal. The method 1200 can include extracting 1210 a third measurement of the one or more calibration magnetic fields and a fourth measurement of the third magnetic field from the second sensor signal. The extracting of the first, second, and third measurements can be implemented by the signal processing circuit 524. The method 1200 can include providing 1212 a signal representing a position at a position output based on the first, second, third, and fourth measurements. For example, providing the signal can be implemented by the position determination circuit 526.

Additionally, the method can include determining one or more gains of the first and second magnetic field sensor units based on the first and second sensor signals, generating the first intermediate signal based on the first sensor signal and the one or more gains, generating the second intermediate signal based on the second sensor signal and the one or more gains, extracting the third measurement of the second magnetic field and the third magnetic field based on combining the first and second intermediate signals, and providing the signal based on the third measurement.

In this description, the term “couple” can cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

In this description, a device that is “configured to” perform a task or function can be configured (e.g., programmed and/or hardwired) at a time of manufacturing by a manufacturer to perform the function and/or can be configurable (or reconfigurable) by a user after manufacturing to perform the function and/or other additional or alternative functions. The configuring can be through firmware and/or software programming of the device, through a construction and/or layout of hardware components and interconnections of the device, or a combination thereof. Furthermore, a circuit or device that is described herein as including certain components can instead be configured to couple to those components to form the described circuitry or device. For example, a structure described herein as including one or more semiconductor elements (such as transistors), one or more passive elements (such as resistors, capacitors, and/or inductors), and/or one or more sources (such as voltage and/or current sources) can instead include only the semiconductor elements within a single physical device (e.g., a semiconductor die and/or integrated circuit (IC) package) and can be configured to couple to at least some of the passive elements and/or the sources to form the described structure, either at a time of manufacture or after a time of manufacture, such as by an end-user and/or a third-party.

The phrase “based on” means “based at least in part on”. Therefore, if X is based on Y, X can be a function of Y and any number of other factors.

In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. A position sensor, comprising:
a first magnetic field sensor unit having a first sensor output;
a second magnet field sensor unit having a second sensor output;
one or more coils having one or more footprints overlapping the first and second magnetic field sensor units; and
a processing circuit having a first sensor input, a second sensor input, a current terminal, and a sensing output, the first sensor input coupled to the first sensor output, the second sensor input coupled to the second sensor output, and the current terminal coupled to the one or more coils.

2. The position sensor of claim 1, wherein the processing circuit is configured to:
provide a calibration current through the one or more coils via the current terminal to cause the one or more coils to provide one or more calibration magnetic fields;
receive a first sensor signal representing the one or more first magnetic fields at the first sensor input;
receive a second sensor signal representing the one or more first magnetic fields at the second sensor input;
determine one or more gains of the first magnetic field sensor unit and the second magnetic field sensor unit based on the first sensor signal and the second sensor signal; and
provide a signal representing a position at the sensing output based on the one or more gains.

3. The position sensor of claim 2, wherein the one or more gains include an average gain of the first and second magnetic field sensor units.

4. The position sensor of claim 2, wherein the one or more gains include a first gain of the first magnetic field sensor and a second gain of the second magnetic field sensor.

5. The position sensor of claim 3, wherein the first sensor signal represents the one or more calibration magnetic fields and a second magnetic field, and the second sensor signal represents the one or more calibration magnetic fields and a third magnetic field; and
wherein the processing circuit is configured to:
extract a first measurement of the one or more calibration magnetic fields from the first sensor signal;
extract a second measurement of the one or more calibration magnetic fields from the second sensor signal;
determine one or more magnitudes of the one or more calibration magnetic fields based on the calibration current; and
determine the one or more gains based on the first and second measurements and the one or more magnitudes.

6. The position sensor of claim 5, wherein the first and second measurements are extracted based on processing, respectively, the first and second sensor signals using at least one of: a bandpass filter, a root mean square operation, an auto-correlation operation, or a Fourier transform operation.

7. The position sensor of claim 5, wherein the processing circuit is configured to:
generate a first intermediate signal based on the first sensor signal and the one or more gains;
generate a second intermediate signal based on the second sensor signal and the one or more gains;
extract a third measurement of the second magnetic field and the third magnetic field based on combining the first and second intermediate signals; and
provide the signal based on the third measurement.

8. The position sensor of claim 7, further comprising a third magnetic field sensor unit having a third sensor output and a fourth magnet field sensor unit having a fourth sensor output,
wherein the one or more footprints overlap the third and fourth magnetic field sensor units;
wherein the processing circuit has a third sensor input and a fourth sensor input, the third sensor input coupled to the third sensor output, and the fourth sensor input coupled to the fourth sensor output; and
wherein the processing circuit is configured to:
receive a third sensor signal representing the one or more first magnetic fields and a fourth magnetic field at the third sensor input;
receive a fourth sensor signal representing the one or more first magnetic fields and a fifth magnetic field at the fourth sensor input;
generate a third intermediate signal based on the third sensor signal and the one or more gains;
generate a fourth intermediate signal based on the fourth sensor signal and the one or more gains;
extract a fourth measurement of the fourth magnetic field and the fifth magnetic field based on combining the third and fourth intermediate signals; and
provide the signal based on a ratio between the third and fourth measurements.

9. The position sensor of claim 1, wherein the one or more coils includes a single coil having a single footprint that overlaps the first and second magnetic field sensor units.

10. The position sensor of claim 9, wherein the single coil surrounds a core region, and the first and second magnetic field sensor units overlap the core region.

11. The position sensor of claim 9, wherein the first and second magnetic field sensor units overlap the single coil.

12. The position sensor of claim 1, wherein the one or more coils includes:
a first coil having a first footprint that overlaps the first magnetic field sensor unit; and
a second coil having a second footprint that overlaps the second magnetic field sensor unit; and
wherein the first coil and the second coil are connected in series.

13. The magnetic position sensor of claim 11, wherein the first coil surrounds a first core region and the second coil surrounds a second core region; and
wherein the first magnetic field sensor unit overlaps the first core region and the second magnetic field sensor unit overlaps the second core region.

14. The magnetic position sensor of claim 11, wherein the first magnetic field sensor unit overlaps the first coil, and the second magnetic field sensor unit overlaps the second coil.

15. The magnetic position sensor of claim 10, further comprising:
a third magnetic field sensor unit having a third sensor output; and
a fourth magnet field sensor unit having a third sensor output;
wherein the one or more coils further includes:
a third coil having a third footprint that overlaps the third magnetic field sensor unit; and
a fourth coil having a fourth footprint that overlaps the fourth magnetic field sensor unit; and
wherein the first, second, third, and fourth coils are connected in series.

16. The magnetic position sensor of claim 1, wherein the first and second magnetic field sensor units are on opposing sides of a semiconductor die, and the one or more coils are on the semiconductor die.

17. The magnetic position sensor of claim 1, wherein each of the first and second magnetic field sensor includes in-plane hall-effect elements.

18. The magnetic position sensor of claim 1, wherein each of the first and second magnetic field sensor includes out-of-plane hall-effect elements.

19. The magnetic position sensor of claim 1, wherein the first magnetic field sensor includes an in-plane hall-effect element, and the second magnetic field sensor includes an out-of-plane hall-effect element.

20. A sensor device, comprising:
a semiconductor die;
a first magnetic field sensor unit having a first sensor output on a first side of the semiconductor die;
a second magnet field sensor unit having a second sensor output on a second side of the semiconductor die opposing the first side;
one or more coils having one or more footprints overlapping the first and second magnetic field sensor units; and
a processing circuit having first and second sensor inputs, a current terminal, and a processing output, the first sensor input coupled to the first sensor output, the second sensor input coupled to the second sensor output, and the current terminal coupled to the one or more coils.

21. The sensor device of claim 20, wherein the one or more coils includes:
a first coil having a first footprint that overlaps the first magnetic field sensor unit; and
a second coil having a second footprint that overlaps the second magnetic field sensor unit,
wherein the first coil and the second coil are connected in series.

22. The sensor device of claim 20, wherein the one or more coils overlap at least a portion of the first magnetic field sensor unit or the second magnetic field sensor unit.

23. The sensor device of claim 20, wherein the one or more coils surrounds one or more core regions, and the first magnetic field sensor unit and the second magnetic field sensor unit overlap the one or more core regions.

24. A method, comprising:
providing a calibration current to one or more coils having one or more footprints that overlap a first magnetic field sensor unit and a second magnetic field sensor unit of a sensor device;
receiving a first sensor signal from the first magnetic field sensor unit, the first sensor signal representing one or more calibration magnetic fields provided by the one or more coils responsive to the calibration current and a second magnetic field;
receiving a second sensor signal from the second magnetic field sensor unit, the second sensor signal representing the one or more calibration magnetic fields and a third magnetic field;
extracting a first measurement of the one or more calibration magnetic fields and a second measurement of the second magnetic field from the first sensor signal;
extracting a third measurement of the one or more calibration magnetic fields and a fourth measurement of the third magnetic field from the second sensor signal; and
providing a signal representing a position at a position output based on the first, second, third, and fourth measurements.

25. The method of claim 24, further comprising:
determining one or more gains of the first and second magnetic field sensor units based on the first and second sensor signals;
generating a first intermediate signal based on the first sensor signal and the one or more gains;
generating a second intermediate signal based on the second sensor signal and the one or more gains;
extracting a third measurement of the second magnetic field and the third magnetic field based on combining the first and second intermediate signals; and
providing the signal based on the third measurement.
